(19) United States
(12) Patent Application Publication
(10) Pub. No.: US 2021/0274828 A1
(43) Pub. Date: Sep. 9, 2021

(54) QUICK DISSOLVE DRINKS AND EDIBLES AND MACHINE FOR MANUFACTURING THE SAME

(71) Applicant: Nicholas J. Singer, Irvine, CA (US)

(72) Inventor: Nicholas J. Singer, Irvine, CA (US)

(21) Appl. No.: 17/329,946

(22) Filed: May 25, 2021

Related U.S. Application Data
(63) Continuation-in-part of application No. 16/144,913, filed on Sep. 27, 2018.
Application No. 16/144,913 is a continuation-in-part of application No. 15/608,886, filed on May 30, 2017, now abandoned.
Application No. 15/608,886 is a continuation-in-part of application No. 15/246,842, filed on Aug. 25, 2016, now abandoned.
Application No. 15/246,842 is a continuation-in-part of application No. 14/954,839, filed on Nov. 30, 2015, now abandoned.
Application No. 14/954,839 is a continuation-in-part of application No. 14/450,113, filed on Aug. 1, 2014, now Pat. No. 9,392,814.
(60) Provisional application No. 62/009,107, filed on Jun. 6, 2014.

(51) Int. Cl. A23P 10/30; A23L 27/00; A23L 33/17; A23L 2/66; A23L 29/262

(52) U.S. Cl. CPC A23P 10/30; A23L 27/72; A23L 33/17; A23V 2002/00; A23L 27/79; A23L 29/262; A23L 2/66

(57) ABSTRACT

A water soluble shell or binder is used to encapsulate nutrients, flavoring, other food grade ingredients or combinations thereof together as a single serving or unit. The unit or single serving may be distributed to people to provide nutrition to people in mass casualty situations. In this manner, more nutrients may be delivered since water which has a significant amount of weight and volume need not be transported to the people. Moreover, in normal situations, the water soluble shell or binder dissolves sufficiently quick so that the user can quickly consume nutrients.

### CROSS-REFERENCE TO RELATED APPLICATIONS

This application is a continuation in part application of U.S. Ser. No. 16/144,913, filed on 2018 Sep. 27, which is a continuation in part application of U.S. Ser. No. 15/608,886, filed on 2017 May 30, now abandoned, which is a continuation in part application of U.S. Ser. No. 15/246,842, filed on 2016 Aug. 25, now abandoned, which is a continuation in part application of U.S. Ser. No. 14/954,839, filed on 2015 Nov. 30, now abandoned, which is a continuation in part application of U.S. Ser. No. 14/450,113, filed on 2014 Aug. 1, now U.S. Pat. No. 9,392,814, which claims the benefit of provisional patent application Ser. No. 62/009,107, filed on 2014 Jun. 6, the entire contents of which are expressly incorporated herein by reference.

### STATEMENT RE: FEDERALLY SPONSORED RESEARCH/DEVELOPMENT

Not Applicable

### BACKGROUND

The various embodiments and aspects described herein relate to a method and apparatus for distribution of drinks, edibles and nutrition.

In order to distribute nutrition to a population, the nutrition is preferably distributed in a self-contained package with water. Alternatively, the base nutritional element may be delivered to the population without water. For example, weight lifters may consume protein by mixing a protein powder in water. The protein powder is distributed and sold to weight lifters while water is locally acquired and mixed with the protein powder as desired by the weight lifter at the time of consumption. Unfortunately, the protein powder is delivered in a large bucket and is cumbersome for the weight lifter to manage. There are also other deficiencies in the prior art.

Accordingly, there is a need in the art for an improved method and apparatus for the delivery of nutrition.

### BRIEF SUMMARY

A drink, edibles and nutrition delivery apparatus that contains nutrition and may be quickly dissolved and mixed in water is disclosed. The nutrition may be encapsulated with a wrapper (e.g., gelatin capsule or film) or a binder in the form of a tablet. The nutrition may also be impregnated within a structure having a flat film configuration, rope configuration, mesh confirmation, finned configuration, honeycomb configuration or combinations thereof. The film, roll, mesh configured delivery apparatus may be bendable so that it can be rolled up for transportation and storage. The wrapper, binder and the impregnated structure (e.g., flat film, rope, mesh, honeycomb or combinations of these configurations) may dissolve in water fairly quickly so that the nutrition is mixed with water quickly. Moreover, the wrapper, binder and the pre-impregnated structure may be inserted into a water bottle at a later date at the time of consumption or any other container designed to hold, mix or contain water liquid.

More particularly, in an aspect, a delivery device for nutritional supplements is disclosed. The device may comprise a nutrient and a water dissolvable shell. The nutrient may be provided as a powder. The water dissolvable shell is used to hold the powdered nutrient for convenient mixing of the powdered nutrient in water when desired. The water dissolvable shell may be fabricated from a material which sufficiently dissolves in water under one (1) minute for mixing of the powdered nutrient with the water in a quick and efficient manner.

The nutrient may be a protein, vitamin, mineral, proprietary nutritional supplement formulation, meal replacement, food product, drink sweetener, caffeine or combinations thereof. An effervescent material may be mixed with the powdered nutrient to promote mixing of the powdered nutrient with the water as the shell dissolves in water.

The water dissolvable shell may be fabricated from a gelatin material. However, it is also contemplated that the material from which the water dissolvable shell is fabricated may alternatively be a natural, water soluble material including but not limited to rice paper, tapioca powder, Amylose, Amylopectin, Silk (Fibroin) Gelatin, Casein, Pullulan, Guar gum, Soybean polysaccharide film, Agar-agar, Arabinoxylan, Alginate sodium, Callaneenan film, Pectin, Hydroxy propyl cellulose film (i.e., HPC film), Hydroxy propyl methyl film (i.e., HPMC film) Carboxymethyl cellulose film, Carboxymethyl film, Cellulose based material, cellulose gum, Decaglycerin monitor myristate, Glycerin, Crystalline cellulose, Hydroxypropylcellulose or combinations thereof. An exemplary combination is Decaglycerin monitor myristate, Glycerin, poly vinyl alcohol (PVA), Crystalline cellulose, Hydroxypropylcellulose which is provided in film form with a thickness of about 0.004 inches thick. The thickness may have a range between 0.001 and 0.010 inches. The shell may be provided in the form of a semi hard shell, soft capsule or flexible film.

The water dissolvable shell may be sufficiently narrow to be slipped through a mouth of a disposable water bottle. In particular, a width of the shell may be less than about two (2) inch in diameter. However, it is also contemplated that the width of the device may be less than about one (1) inch in diameter.

In another embodiment, a delivery device for nutritional supplements is disclosed. The device may comprise a food product and a water dissolvable binder. The food product may be provided as a powder. The water dissolvable binder may be used to hold the powdered food product (e.g., nutrient, carbohydrate, protein, flavoring, sugar or combinations thereof) in a solid form for convenient mixing of the powdered nutrient in water. The water dissolvable binder may be dissolved in water under one (1) minute for mixing of the powdered nutrient with the water.

The nutrient may be protein, vitamin, mineral, proprietary nutritional supplement formulation, meal replacement, food product, drink sweetener, caffeine or combinations thereof. An effervescent material may be mixed with the powdered nutrient to promote mixing of the powdered nutrient with the water as the binder dissolves in water.

The device may be sufficiently narrow to be slipped through a mouth of a disposable water bottle. In particular, a width of the device may be less than about two (2) inch in diameter. However, it is also contemplated that the width of the device may be less than about one (1) inch in diameter.

In another aspect, a method of manufacturing a delivery device for conveniently mixing a nutrient with water is disclosed. The method may comprise the steps of providing a water dissolvable shell that is sufficiently dissolvable in water under one (1) minute so that water comes into contact with contents disposed within the shell; providing the nutrient as a powder; filling the powdered nutrient in the water dissolvable shell; sealing the water dissolvable shell for holding the powdered nutrient until use when a user disposes the delivery device into a container with water, shakes the container to mix the powdered nutrient as the shell dissolves in the water.

The providing step may include the step of providing a gelatin based water dissolvable shell. Alternatively or additionally, the providing step may include the step of providing a micro film based water dissolvable shell.

In another aspect, a method of manufacturing a delivery device for conveniently mixing a nutrient with water is disclosed. The method may comprise the steps of providing a water dissolvable binder that is sufficiently dissolvable in water under one (1) minute; providing the nutrient as a powder; mixing the binder and the powdered nutrient; filling a die with the mixed binder and powdered nutrient; and compressing the mixed binder and powered nutrient.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front view of a first embodiment of a nutrition delivery apparatus;

FIG. 2 illustrates the nutrition delivery apparatus of FIG. 1 being inserted into a water bottle;

FIG. 3 illustrates the nutrition delivery apparatus of FIG. 2 as a water soluble wrapper of the nutrition delivery apparatus dissolves to enable mixing of the nutrition in the apparatus to mix with the water;

FIG. 4 is a flow chart illustrating use of the nutritional delivery apparatus;

FIG. 5 is a flow chart illustrating a method for manufacturing first and second embodiments of the nutrition delivery apparatus;

FIG. 6 illustrates a first step of providing an empty first body for filling the nutrition therein with a nozzle;

FIG. 7 illustrates a second step of introducing the nutrition in the first body;

FIG. 8 illustrates a third step of closing the first body with a second body for forming a capsule;

FIG. 9 illustrates a second embodiment of the nutrition delivery apparatus being inserted into the water bottle;

FIG. 10 illustrates the nutrition delivery apparatus of FIG. 9 as a water soluble wrapper of the nutrition delivery apparatus dissolves in water to enable mixing of the nutrition in the apparatus to mix with the water;

FIG. 11 illustrates a third embodiment of the nutrition delivery apparatus being inserted into the water bottle;

FIG. 12 illustrates the nutrition delivery apparatus of FIG. 11 as a water soluble binder of the nutrition delivery apparatus dissolves in the water to enable mixing of the nutrition in the apparatus to mix with the water;

FIG. 13 illustrates a first step of providing an empty die for filling the nutrition therein with a nozzle;

FIG. 14 illustrates a second step of introducing the nutrition and a binder in the die;

FIG. 15 illustrates a third step of compressing the nutrition and the binder for forming a tablet;

FIG. 16 is a flow chart illustrating a method for manufacturing the third embodiment of the nutrition delivery apparatus;

FIG. 17 is a perspective view of a fourth embodiment of the nutrition delivery apparatus having a roll configuration;

FIG. 18 is a perspective view of the fourth embodiment of the nutrition delivery apparatus having a strip configuration;

FIG. 19 is a perspective view of the fourth embodiment of the nutrition delivery apparatus having a honeycomb configuration;

FIG. 20 is a perspective view of the fourth embodiment of the nutrition delivery apparatus having a rope configuration;

FIG. 21-40 discloses another aspect of the device and method described herein;

FIG. 21 is a perspective view of a packet and a water bottle;

FIG. 22 is a front view of the packet and water bottle being inserted into the water bottle;

FIG. 23 is a front view of the packet shown in FIGS. 1 and 2;

FIG. 24 is a cross-sectional side view of the packet shown in FIG. 3;

FIG. 25 is a transverse cross-sectional view of the packet shown in FIG. 3;

FIG. 26 is a front view of another embodiment of the packet shown in FIG. 3;

FIG. 27 is a cross-sectional side view of the packet shown in FIG. 6;

FIG. 28 is a transverse cross-sectional view of the packet shown in FIG. 6;

FIG. 29 is a perspective view of a machine for forming the packet;

FIG. 30 is a close-up view of a portion of the machine shown in FIG. 9;

FIG. 31 is a close-up view of another portion of the machine shown in FIG. 9;

FIG. 32 is a close-up view of a further portion of the machine shown in FIG. 9;

FIG. 33 is a cross-sectional view of a film with an ingestible powdered nutrient disposed in a tube formed by the film;

FIG. 34 is a perspective view of another machine for forming the packet;

FIG. 35 is a front view of the machine shown in FIG. 14;

FIG. 36 is a side view of the machine shown in FIG. 14 before the machine forms a horizontal seal with horizontal heaters;

FIG. 37 is a side view of the machine shown in FIG. 14 when the machine forms the horizontal seal with the horizontal heaters and before powdered food product is dropped into a tube configured film;

FIG. 38 is a side view of the machine shown in FIG. 14 when the machine pulls down a tube configured film as the powdered food product is dropped into the tube configured film and cuts the horizontal seal with a cutter;

FIG. 39 is a side view of the machine shown in FIG. 14 when the horizontal heater releases the tube configured film and powdered food product is dropped into the tube configured film and the cutter is opened; and

FIG. 40 is a side view of the machine shown in FIG. 14 when the horizontal heater is traversed upward to start the cycle again.

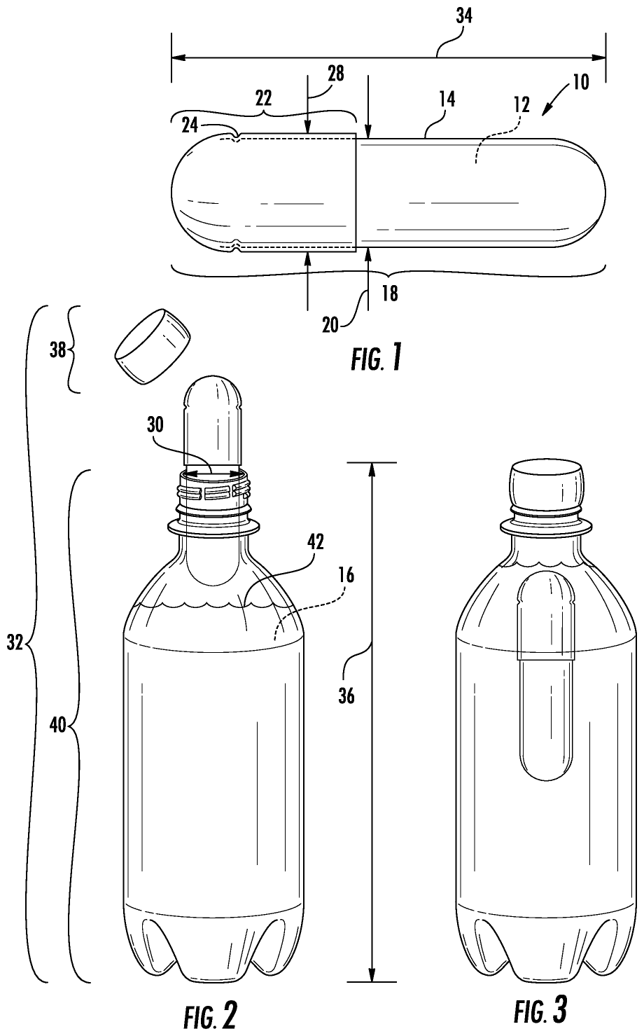

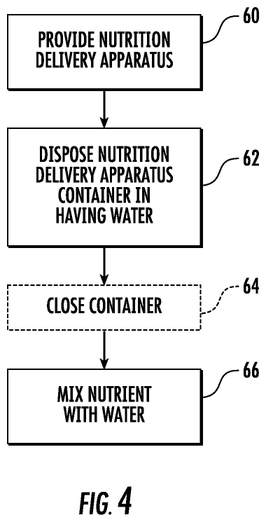

### DETAILED DESCRIPTION

Referring now to the drawings, a method and apparatus 10, 100, 200, 300 for delivering nutrition 12 to a person is shown. In particular, the nutrition 12 is encapsulated within a shell 14, 114 and/or bound together with a binder 214 as a tablet 200 or solid form. Additionally, the nutrition 12 may be pre-impregnated within a structure (e.g., film or flat sheets, honeycomb, mesh, rope or combinations thereof). The shell 14, 114, the binder 214 and pre-impregnated flexible structure 300 are dissolvable in water 16. Preferably, the shell 14, 114, the binder 214 and the pre-impregnated flexible structure 300 are formulated to dissolve sufficiently quick so that the nutrition 12 can be mixed with the water 16 within one minute. More preferably, the shell 14, 114, the binder 214 and pre-impregnated flexible structure 300 are formulated to dissolve in room temperature water without agitation within one minute, and preferably within 10 seconds so that the nutrition 12 may be consumed quickly after deployment. To deliver nutrition 12 to a person, the apparatus 10, 100, 200, 300 provides a small package that can be conveniently delivered to the person. Water which takes up space and is heavy makes delivering the nutrition 12 pre-mixed with water expensive and impractical. The method and apparatus 10, 100, 200, 300 disclosed herein provides practical applications to athletes, delivery of nutrition 12 in mass casualty situations and combat situations, supplementation, and other real-life problems.

The nutrition 12 may consist of proteins, protein formulations, carbohydrates, fats, vitamins, minerals, proprietary nutritional supplement formulation, meal replacement, food product, drink sweetener, caffeine, dried coffee, consumable additives or combinations thereof. The nutrition may be designed as a vitamin supplement, energy formulation, weight loss formulation, energy formulation, workout recovery formulation, pre-workout formulation, memory enhancement formulation and knee and joint repair formulation. The proprietary nutritional supplement may include combinations of vitamins and supplements to accomplish a desired goal such as weight loss, increased energy, recovery after workout, pre-workout, memory enhancement and joint repair. However, the nutrition 12 may be replaced with other types of food products. By way of example and not limitation, the food products may be flavoring, coloring. The nutrition 12 may also be combined with the food product and provided in the shell 14, 114 and/or held together with the binder 214. The nutrition 12 or food product may be dissolvable in a liquid 16 (e.g., water) and/or suspended therein. Additionally, it is also contemplated that the nutrition 12 and/or food product may be homogeneously or heterogeneously mixed with the liquid 16. It is also contemplated that the nutrition 12 and/or food product may be partially dissolvable in the liquid 16 so as to form a combination homogeneous and heterogeneous mixture with the liquid 16. For the purposes of clarity and simplification, the methods and apparatuses 10, 100, 200, 300 described herein are discussed in relation to delivering nutrition 12 to a person for subsequent mixture by the person with liquid 16. However, it is also contemplated that the various aspects described herein may be applicable to delivering other food products excluding nutrition 12 or in combination with nutrition 12 to the person for subsequent mixture by the person with liquid 16.

Referring now to FIG. 1, the apparatus 10 for delivering nutrition 12 to a person is shown. The nutrition delivery apparatus 10 has a quick dissolve shell 14 in the form of a capsule 14. The interior and/or exterior surface of the shell 14 may have indicia (e.g., words, logo, design or combinations thereof) imprinted thereon. The capsule 14 may be fabricated from a gelatin material. Alternatively or in combination with the gelatinous material, rice powder, rice paper, tapioca powder may be used to formulate the capsule 14 to be dissolve in room temperature drinking water within a short period of time (e.g., less than 1 minute, and more preferably less than 10 seconds). The gelatinous material may be infused with color. Also, the exterior and/or interior surface of the capsule 14 may have indicia (e.g., words, logo, design and/or combinations thereof) imprinted thereon. The capsule 14 may have a hard shell with the nutrition 12 disposed therein. In this case, the nutrition 12 may be in the form of dry granules or powder. Alternatively, the capsule 14 may have a soft shell with the nutrition 12 disposed therein. In this case, the nutrition 12 may be dissolved or suspended in a carrier liquid (e.g., oil). The capsule 14 may be a two-piece hard shell component, as shown in FIG. 1. In particular, a first body 18 may have an outer diameter 20 and be capable of holding the nutrition 12 therein. A second body 22 may have a snug fit over the open end portion of the first body 18. Moreover, the second body 22 may have a lip 24 that fits within a groove 26 formed in the first body 18 for holding the second body 22 on the first body 18. With the nutrition 12 disposed within the capsule 14, the nutrition delivery apparatus 10 may be transported in bulk to stores or mass casualty situations for providing nutrition 12 to people when needed.

The capsule 14 may also have an outer diameter 28 defined by the second body 22. Preferably, the outer diameter 28 of the capsule 14 is smaller than an inner diameter 30 of a mouth of the water bottle 32. The inner diameter 30 of the mouth of the water bottle 32 may be about ½ inch to about 2″. The mouth is sufficiently small so that the person cannot access the interior of the water with his or her finger. The water bottle 32 may be a traditional disposable water bottle 32 such as those sold by water bottling manufacturers. Additionally, the capsule 14 may have a length 34 that is shorter than an internal height 36 of the water bottle 32. Preferably, the capsule 14 is less than one half the height 36 of the water bottle 32. More preferably, the capsule 14 has an outer diameter 28 of about ¾ inch to two (2) inches and a length 34 of two (2) to eight (8) inches. The capsule 14 is shown as being spherical at the opposed end portions with an elongate cylindrical mid section. However, other configurations are also contemplated. By way of example and not limitation, the opposed end portions may have a flat end cap.

The nutrition delivery apparatus 10 may be delivered to stores for further distribution to the public or to an area experiencing a natural disaster or pandemic. People may be sustained by the nutrition 12 within the nutrition delivery apparatus 10 by mixing the nutrition delivery apparatus 10 with water locally acquired. In this manner, the volume and weight of the water does not have to be transported with the nutrition.

By way of example and not limitation, people may insert the nutrition delivery apparatus 10 into the water bottle 32. The user may acquire water 16 locally. The water discussed herein may be drinking water with a pH between about 6.5 to about 8.5. The temperature of such drinking water may be between 60° F. and 85° F. The nutrition delivery apparatus 10 may be transported to the person when needed such as during time of combat, mass casualty and other pandemics. The user may remove a bottle cap 38 from a body 40 of the water bottle 32. Since a water level 42 is typically close to the top of the body 40, the user may drink some of the water 16 in the water bottle 32 to lower the water level 42. The nutrition delivery apparatus 10 may be inserted 62 into the mouth of the water bottle 32. When the nutrition delivery apparatus 10 is inserted into the mouth of the water bottle 32, the nutrition delivery apparatus 10 may remain in a non-agitated state in that there is no external force (e.g., tongue, finger) directly contacting and rubbing against the nutrition delivery apparatus 10 to facilitate dissolution. The nutrition delivery apparatus 10 displaces the water 16 or raises the water level within the water bottle 32. Preferably, the user emptied out the water 16 from the water bottle 32 just enough for the water 16 not to spill over when the nutrition delivery apparatus 10 is inserted into the water bottle 32. Once the nutrition delivery apparatus 10 is inserted into the water bottle 32, the user places 64 the bottle cap 38 on to the body 40 to seal 54 the water 16 and the nutrition delivery apparatus 10 in the body 40 of the water bottle 32.

When the nutrition delivery apparatus 10 is inserted into the body 40, the shell 14 comes into contact with the water 16 disposed in the body 40 of the water bottle 32. Upon contact, the shell 14 begins to dissolve into the water 16 so that the nutrition 12 disposed within the shell 14 begins to mix 66 with the water 16. As the water 16 dissolves the shell 14, the nutrition 12 disposed within the shell 14 begins to mix 66 with the water 16. Optionally, the user may shake the water bottle 32 to more evenly dispersed the nutrition 12. However, shaking is not necessary to dissolve the shell 14 in under 1 minute. Once mixed, the user removes the bottle cap 38 from the body 40 then drinks the water 16 mixed with the nutrition 12.

The method and apparatus 10, 100, 200, 300 described herein allow for inexpensive distribution of nutrition 12 by not having to transport water 16 with the nutritional elements.

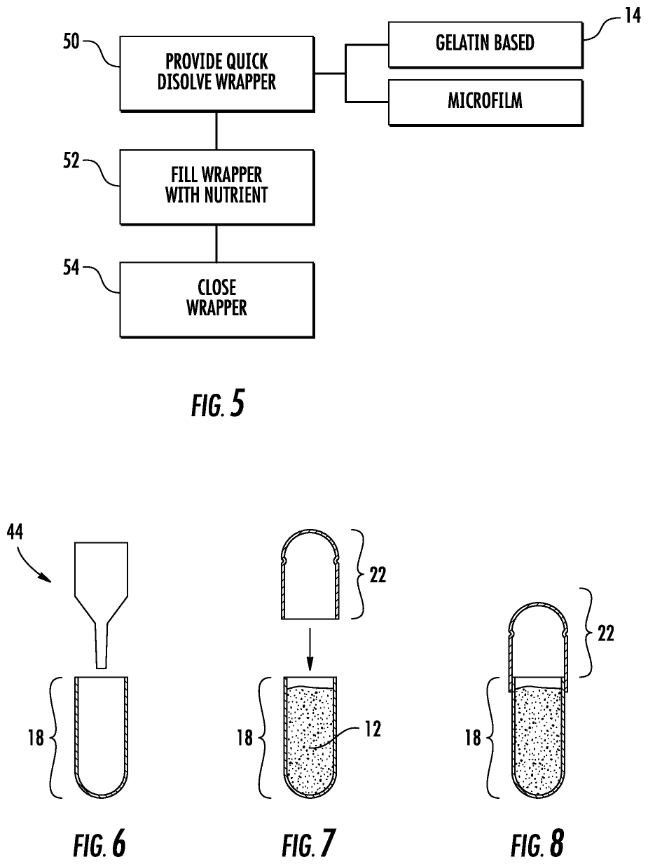

Referring now to FIGS. 5-8, a method for manufacturing the nutrition delivery apparatus 10 is shown. In particular, the quick dissolve shell 14 is provided 50. The quick dissolve shell 14 is provided in two parts, namely, the first body 18 and a second body 22. Initially, the first body 18 is placed under a nozzle 44 which dispenses the nutrition 12 therethrough. The nozzle 44 disposes 52 the nutrition 12 within the cavity 204 of the first body 18. Thereafter, the second body 22 is disposed over the first body 18 then pressed over the first body 18 to seal 54 the nutrition 12 in the shell 14. This forms the nutrition delivery apparatus 10.

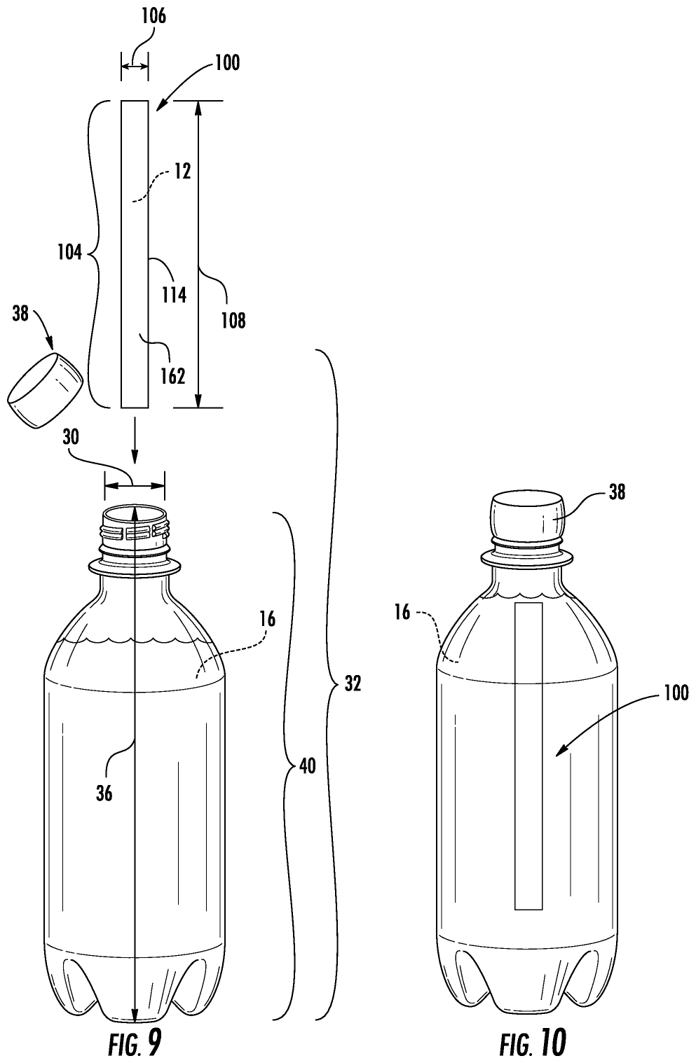

Referring now to FIGS. 9 and 10, a second embodiment of the nutrition delivery apparatus 100 is shown. In this embodiment, the nutrition 12 is provided as a flexible edible film 102. The film 102 may be a water soluble polymer film. The flexible film 102 is formed as a pouch 104 for holding the nutrition 12 therein. The pouch 104 has a width 106 which is smaller than the inner diameter 30 of the water bottle 32 so that the nutrition delivery apparatus 100 may be inserted (or slipped) into the mouth of the water bottle 32. Moreover, the pouch 104 has a length 108 which is smaller than the height 36 of the water bottle 32. The length may be between 2 inches to 6 inches. More preferably, the length 108 of the pouch 104 is about one half or less than the height 36 of the water bottle 32.

Similar to the first embodiment, the user removes (i.e., un-screws) the bottle cap 38 off of the body 40 of the water bottle 32. The user may drink a portion of the water 16 in the body 40 to make room for the volume to be displaced by the nutrition delivery apparatus 100. The nutrition delivery apparatus 100 is inserted into the body 40 through the mouth of the body 40. Once the nutrition delivery apparatus 100 is disposed 62 within the body 40, the bottle cap 38 is used to seal 54 off the mouth of the body 40, as shown in FIG. 10. As soon as the nutrition delivery apparatus 100 contacts the water 16, the film 102 begins to dissolve in the water 16 and the nutrition 12 begins to mix 66 with the water 16. Optionally, the user may shake the water bottle 32 to facilitate further mixing 66 until all of the nutrition 12 is mixed with the water 16. However, shaking is not required to dissolve the film 102 in under 1 minute. Thereafter, the user may remove the bottle cap 38 and drink the water 16 mixed with nutrition 12.

To manufacture the nutrition delivery apparatus 100, the film 102 is provided as a pouch 104. One end of the pouch 104 is opened so that the nozzle 44 may be disposed over or in the opening for filling the pouch 104 with nutrition 12. After the nutrition 12 is disposed 62 within the pouch 104, the pouch 104 may be sealed 54 for storage and distribution.

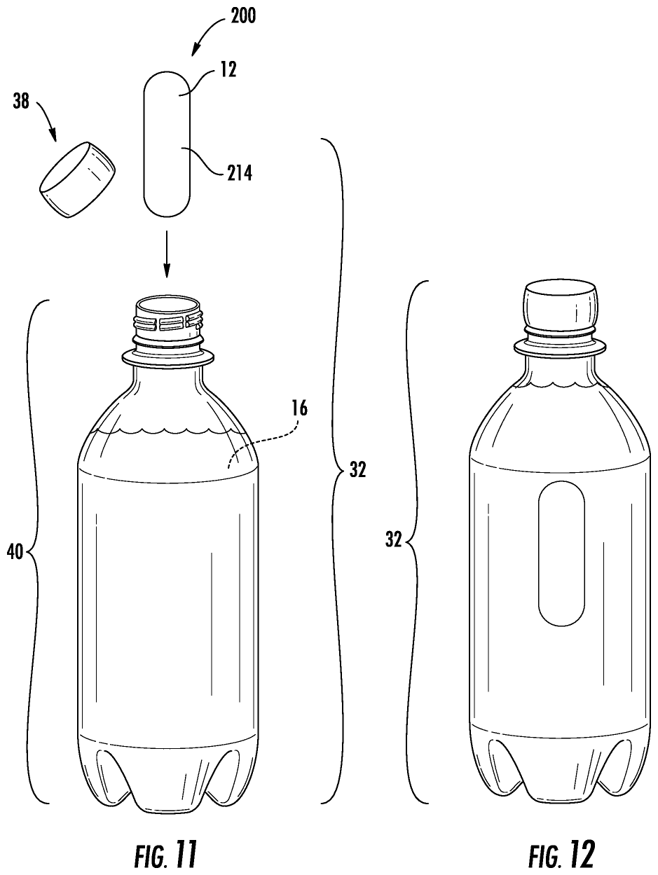

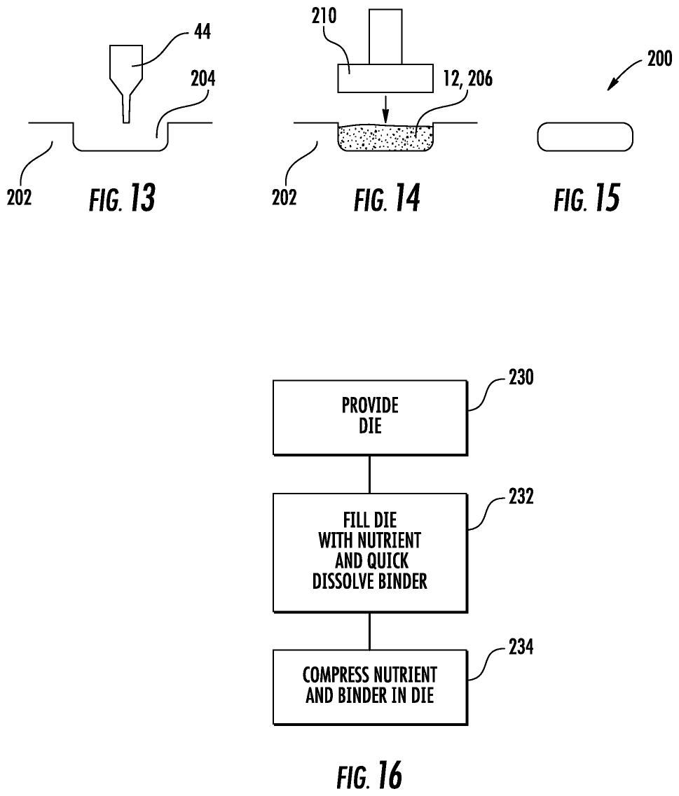

Referring now to FIGS. 11-16, a third embodiment of the nutrition delivery apparatus 200 is shown. The nutrition delivery apparatus 200 tablet is formed so that the nutrition 12 is held together with the binder 206. The binder 206 may be sodium bicarbonate, stearic acid, magnesium stearate, cellulose gum, or a combination thereof. The binder 206 is water dissolvable. As such, the nutrition delivery apparatus 200 begins to mix 66 the nutrition encapsulated with the binder 206 as soon as the nutrition delivery apparatus 200 is inserted into the water 16 in the water bottle 32. After inserting the nutrition delivery apparatus 200 in the water 16, the bottle cap 38 is used to seal off 54 the mouth of the water bottle 32. Optionally, the user may shake the water bottle 32 to facilitate mixing 66. However, shaking is not required to dissolve the nutrition delivery apparatus in under one minute. When the binder 206 has completely dissolved, the nutrition 12 may be fully mixed 66 with the water 16. The user may remove the bottle cap 38 to drink the water 16 with nutrition 12. Alternatively, the nutrition 12 may be bound together with the binder 206 and an effervescent material 208 to facilitate mixture 66 of the nutrition 12 with the water 16. In this case, the bottle cap 38 is not placed on the body 40 of the water bottle 32. Rather, the bottle cap 38 is left off of the body 40 so that the effervescent material 208 may produce gas and escape into the atmosphere. The nutrition delivery apparatus 200 may be provided in the form of a tablet and be sized and configured to be able to fit within the mouth opening of the body 40. However, it is also contemplated that the bottle cap 38 may be threaded onto the body 40 of the water bottle 32 while allow the effervescent material 208 to facilitate mixture 66 of the nutrition with the water.

Referring now more particularly to FIGS. 13-16, a method of manufacturing the nutrition delivery apparatus 200 is shown. Initially, a die 202 is provided 230. The die 202 may have a cavity 204 which is sized and configured so that the final form of the nutrition delivery apparatus 200 can be inserted into the mouth of the water bottle 32. The nozzle 44 is disposed over the cavity 204 of the die 202. The nozzle 44 is operative to fill 232 the cavity 204 with (1) the nutrition 12 and the binder 206 or (2) the nutrition 12, the binder 206 and an effervescent material 208. Once the nutrition 12 and the binder 206 and/or effervescent material 208 are disposed within the cavity 204 of the die 202, a press 210 compresses 234 the mixture. When the press 210 is removed, the nutrition delivery apparatus 200 is removed from the cavity 204.

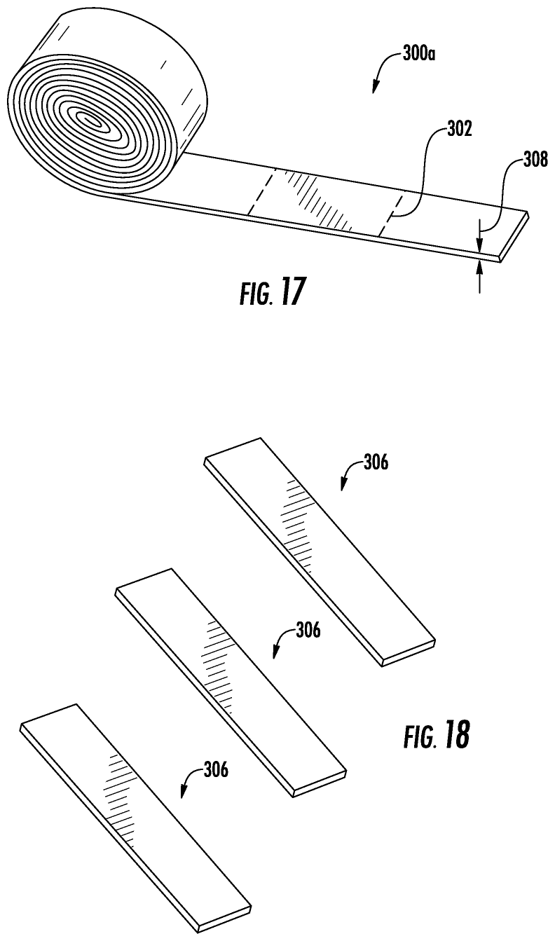

Referring now to FIGS. 17-20, a fourth embodiment of the apparatus 300 is disclosed. The apparatus 300 may be a pre-impregnated structure. The pre-impregnated structure may have various configurations such as strip, honeycomb, mesh, rolled rope configurations. The pre-impregnated structures 300 may be rolled or provided for transportation in a stacked fashion. By way of example and not limitation, FIG. 17 illustrates pre-impregnated structure 300a being provided as a rolled strip. In this regard, the strip 300a is flexible in nature so as to be rollable. The rolled strip 300 may be transported to a location for later mixture with water in a standard water bottle or another container useful for mixing the rolled strip 300a into the water. The rolled strip 300a may have preprinted dosage lines 302 so that the user may cut the strips to appropriate lengths for mixture with an appropriate amount of nutrition 12 and water. By way of example and not limitation, the user may mix X number of strips with 8 fluid ounces of water depending on the size of the person to provide the appropriate amount of nutrition to the person. The preprinted dosage lines 302 may additionally or alternatively be perforations formed in the strip 300a so that the user need not use a pair of scissors to cut the strip but may simply tear the strip at an appropriate perforated dosage line 302.

Referring now to FIG. 18, the strip 300a may be provided as short strips 306 instead of a long strip which is rolled up. The strip 300a may have a thickness 308 of between 1 mm and 40 mm.

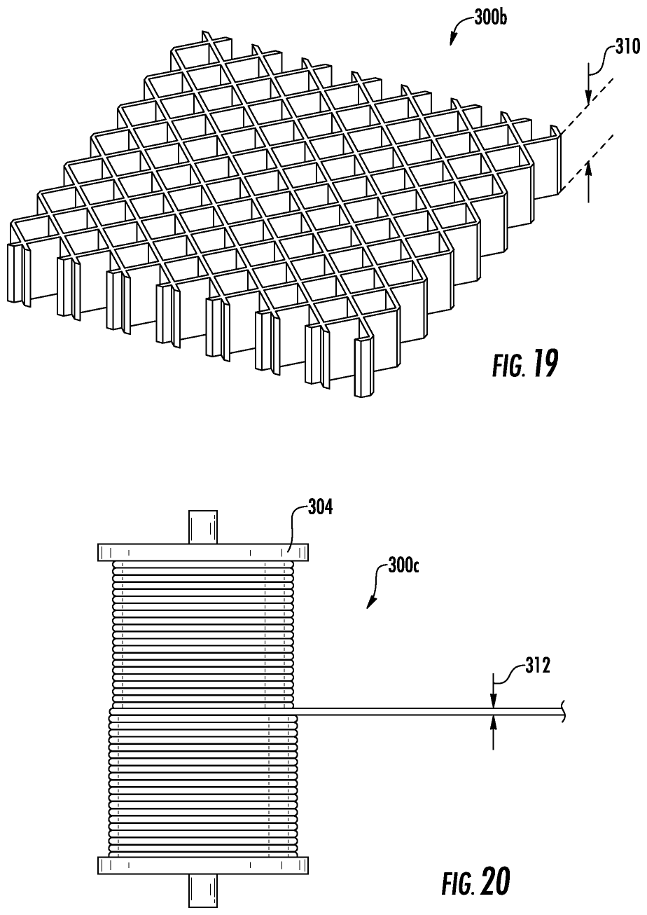

Referring now to FIG. 19, a second embodiment of the pre-impregnated structure 300b is shown. The pre-impregnated structure 300b is formed as a honeycomb structure. By forming the pre-impregnated structure into a honeycomb structure, when the apparatus 300b is submersed in water, the honeycomb structure 300b increases the surface area contact between the structure 300b and the water so as to increase the dissolveability and reduce the amount of time required to dissolve the structure 300b in the water and mix the nutrition 12 with the water. The honeycomb structure 300b is shown when flat. However, the honeycomb structure may also be provided in a rolled up form on a spool. It is also contemplated that the honeycomb structure 300b may also be cut to size with a pair of scissors or a utility knife to mix the appropriate amount of nutrition impregnated in the structure 300b with water based on the person's size. The honeycomb structure 300b may have a thickness 310 between 1 mm and 40 mm. Additionally, the honeycomb structure 300 may be provided in other configurations such as mesh or finned structure in order to increase the surface area contact between the water and the structure 300b.

Referring now to FIG. 20, a third embodiment of the pre-impregnated structure 300c is shown. The structure 300c is a rope configuration that may be rolled on a spool 304 so that the user can unwind the structure 300c and cut off the appropriate amount of nutrition based on the length of the structure 300c. The rope configuration 300c may have a diameter 312 between 1 mm and 40 mm. Moreover, the rope configuration of the structure 300c may have a single or multiple twine that are twisted with each other and may be cut to length with a scissor or utility knife. By providing multiple twines that are twisted together, such configuration increases the surface area contact between the water and the rope configured pre-impregnated structure 300c to improve dissolveability and to reduce the time to completely dissolve the structure 300c placed in the water.

The various structures 300a-c may be formed by extrusion or molding. The nutrition 12 may be mixed with a binder which may be flexible when cured so that the structure 300a-c may be rolled up. The preimpregnated structure may be fabricated from the binder which may include but is not limited to cellulose gum, gelatinous material, rice powder, rice paper, tapioca powder, or combinations thereof. In this regard, the preimpregnated structure may be characterized as the delivery means by which the food product (e.g., protein, sugar, nutrition, carbohydrate, or combinations thereof) is stored, transported and used to mix the food product into the water. It is also contemplated that the binder may be rigid when cured.

The nutrition delivery apparatus 10, 100, 200, 300 may be manufactured with multiple water dissolving substrates. By way of example and not limitation, the nutrition 12 may be provided as a tablet then disposed within the shell 14, 114. The shells 14, 114 may be layered on top of each other. Either the shell 14 may be layered under the shell 114, or the shell 114 may be layered under shell 14. Also, the shell 14, 114 and the binder 206 may be fabricated from food grade ingredients so that the nutrition delivery apparatus 10, 100, 200 may simply be mixed with water then consumed without filtering out the shell 14, 114 or binder 206 in a post processing step.

The nutrition delivery apparatus 10, 100 may be provided so that it sinks to the bottom of a water bottle after being inserted into the water bottle. The capsule 14 and the pouch 104 may be air tight and vacuumed to remove the air within the capsule 14 and the pouch 104. Additionally, the nutritional delivery apparatus 10, 100, 200 may have a solid non dissolvable core/object or a core/object that dissolve slower than the rest of the nutrients. In this manner, as the water soluble shell 14, film 102 or binder 206 dissolves, the user may shake the water bottle so that the non dissolvable or slowly dissolving core or object is used to mix the nutrition 12 with the water 16.

The various aspects described herein was in relation to a nutrition delivery apparatus that may be slipped into a narrow mouth of a water bottle. When the nutrition delivery apparatus is disposed in the water bottle, the mouth of the water bottle prevents the user from reaching in with his or her finger to rub the nutrition delivery apparatus to speed up dissolution of the nutrition delivery apparatus in the water. In this regard, the dissolution of the nutritional delivery apparatus occurs without agitation and in under 1 minute and preferably under 10 seconds. It is also contemplated that the nutrition delivery apparatus may be inserted into other types of wide mouth containers such as a water cup and a shaker bottle. In this instance, the diameter of the nutrition delivery apparatus may be significantly larger than 2 inches.

The water in which the nutrition delivery apparatus is disposed in to dissolve may be drinking water with a pH between about 6.5 to about 8.5. The temperature of such drinking water may be between 60° F. and 85° F.

The above description is given by way of example, and not limitation. Given the above disclosure, one skilled in the art could devise variations that are within the scope and spirit of the invention disclosed herein, including various ways of distribution of the nutrition delivery apparatus 10, 100, 200 to people. Further, the various features of the embodiments disclosed herein can be used alone, or in varying combinations with each other and are not intended to be limited to the specific combination described herein. Thus, the scope of the claims is not to be limited by the illustrated embodiments.

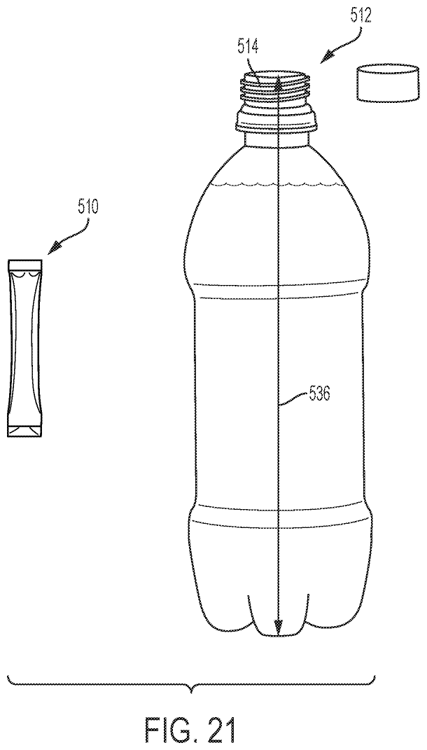

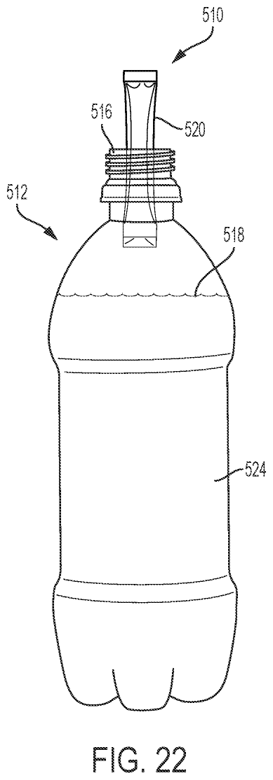

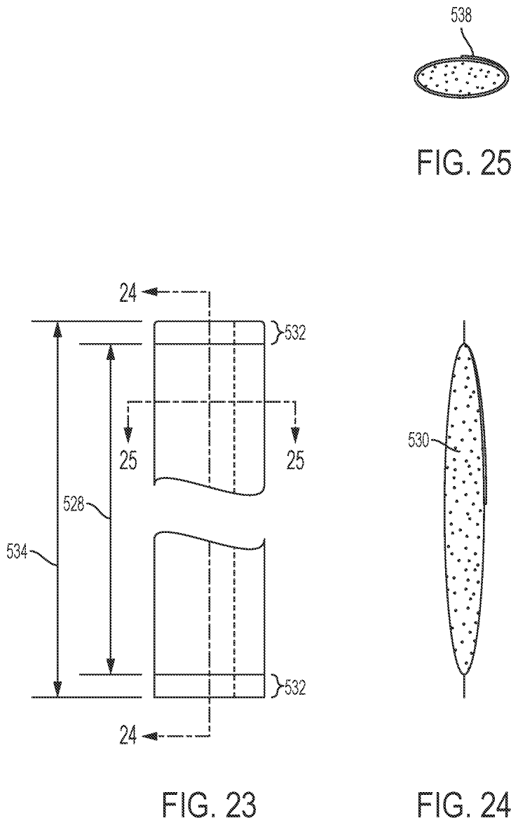

Referring now to the FIGS. 21-40, different aspects of the device and method are disclosed herein. More particularly, a drop and drink nutritional packet 510 and a disposable water bottle 512 are shown. The user may remove a cap 514 of the water bottle 512 and insert the packet 510 into a mouth 516 of the water bottle 512. At least a portion of the packet 510 will be submersed under a water line 518 of the water in the disposable water bottle 512. The packet 510 has a tubular configuration and its exterior may be fabricated from a film 5520 that dissolves in less than 2 minutes when in contact with still water 5524. When the packet 510 is dropped into the water 524 of the water bottle 512, within two minutes, the film 520 dissolves in the water as a homogeneous solution and the powdered nutrients 522 disposed in a tube formed by the film 520 is dispersed into the water as a heterogeneous solution. The packet 510 is entirely ingestible. When the packet 510 is dropped into the water 524, everything that is dropped into the water 524 and is associated with the packet 510 can be ingested by the user. Within two minutes, the user can drink the nutritious beverage without having to retrieve anything from within the water 524 or the water bottle 512 so that the packet 510 allows the user to drop the packet 510 into the water 524 of a disposable water bottle 512 and drink a nutritious beverage in less than two minutes. To speed up the process, the user can also shake the water bottle 512. By doing so, the powdered nutrients 522 disposed in the tube formed by the film 520 rub against the film and further accelerate the dissolution of the film into the water. When shaking the water bottle 512, the user can enjoy a nutritious beverage less than 520 or 530 seconds after dropping the packet 510 into the water and shaking the water bottle 512.

More particularly, the drop and drink packet 510 allows the user to drop the packet 510 into the mouth 516 of the water bottle 512, wait two minutes or less to allow a tube 526 of the packet 510 to dissolve into the water 524 as a homogeneous solution and allow the powdered nutrients 522 to be dispersed into the water 524 as a heterogeneous solution. Within two minutes or less after dropping the packet 510 into the water, the user can drink the nutritious beverage. To reduce the time to less than 530 seconds, the user can shake the water bottle 512 after dropping the packet 510 into the water bottle 512.

The drop and drink packet 510 may define a length 528. The length 528 is a length of an interior volume 530 of the packet 510. Opposed end portions 532 are sealed so as to be airtight. The packet 510 is fabricated from a film material that can bend. When the packet 510 is inserted into the water bottle 512, the end portions 532 can fold over so that should an overall length 534 of the packet 510 be greater than an interior height 536 of the water bottle 512, the end portions 532 can fold over and allow the packet 510 to be fully encased within the water bottle 512.

The length 528 of the interior volume 530 of the packet may be between 2 inches and 12 inches. Preferably, the length of the interior volume is between 3 to 7 inches. The length 528 of the interior volume 530 may be sufficiently short so that the entire packet 510 fits within the water bottle 512 when a cover cap 514 is screwed on to the bottle 512. The packet 510 is not rigid and can bend slightly so that if needed, the packet 510 can be squished into the bottle 512 by forcing the packet 510 into the bottle 512 completely. Even if the tube 526 of the packet 510 breaks when squished into the disposable water bottle, this is not a detriment to the utility of the packet 510 because the goal of the packet 510 is to quickly disperse the powdered nutrients 522 into the water. Breaking the packet 510 would only expedite such goal.

The length 528 of the interior volume 530 of the packet 510 may be sufficiently long so that the interior volume 530 can hold a determined amount of powdered nutrients. By way of example and not limitation, the length 528 of the interior volume 530 of the packet 510 may be sufficiently long to hold 5 g, 10 g, 15 g, 30 g, 60 g or 90 g of powdered nutrients. Other amounts of nutrients are also contemplated including but not limited to any amount between 10 mg and 120 mg.

The packet 510 may also have a seal along fin 538. The seal along the fin 538 extends along a longitudinal edge of the packet 510.The fin seal 538 is airtight which along with the airtight seals on the end portions 532 fully encapsulate the interior contents (e.g. powdered nutrients) so that moisture in the air does not degrade the quality of the powdered nutrients in the packet 510 over an extended period of time. Rather, the airtight seals keep the powdered nutrients fresh over a longer period of time (e.g. about 30 days, 60 days, 90 days).

The film used to fabricate the tube 526 of the packet 510 may be hydroxypropyl methyl cellulose. The hydroxypropyl methyl cellulose film is provided in a thickness sufficient to allow the hydroxypropyl methyl cellulose film to dissolve in still drinking water at a pH of 7 having a temperature of 45° F.-50° F. in less than two minutes. By way of example and not limitation, the thickness of the hydroxypropyl methyl cellulose film may be between 0.001 inch thick and 0.0510 inch thick. Hydroxypropyl methyl cellulose is a preferred material for fabricating the film but the other materials are also contemplated. By way of example and not limitation, the film may be fabricated from rice paper, tapioca powder, amylose, amylopectin, silk (fibroin) gelatin, casein, pullulan, guar gum, soybean polysaccharide film, agar-agar, arabinoxylan, alginate sodium, callaneenan film, pectin, hydroxypropyl cellulose film (i.e., HPC film), hydroxypropyl methyl film (HPMC film), carboxymethyl film, decaglycerin monitor myristate, glycerin, crystalline cellulose, hydroxypropyl cellulose or combinations thereof. More particularly, the film may be fabricated from hydroxypropyl methyl cellulose, glycerin, propylene glycol, Oak fiber, PEG 600 (polyethylene glycol 600), polysorbate 80 or combinations thereof. The film may be air impermeable so that when the packet is sealed on the ends and along its longitudinal lengths, no air enters the packet.

The temperature of the drinking water in the disposable water bottle may be 45° F.-50° F. and the pH of the water may be 7. Broadly speaking the temperature of the drinking water may be between 32° F. and 65° F. and yet still allows the film 520 to dissolve in the water as a homogeneous solution and the powdered nutrients 522 to be disbursed into the water as a heterogeneous solution in less than two minutes after submersion of the packet 510 in the water. Moreover, the pH of the water may be between 6.5 to 8.5 and is preferably above 7.0. The thickness of the hydroxypropyl methyl cellulose film may be at its lower range when the temperature of the drinking water is colder than 45° F.-50° F. and the pH of the drinking water is above 7. The thickness of the hydroxypropyl methyl cellulose film may be at its upper range when the temperature of the drinking water is more than 45° F.-50° F. and the pH of the drinking water is below 7. In use, the packet 510 may be distributed to people in a mass casualty situation. The packet 510 provides nutrients to the people affected by the mass casualty situation. Provided that the affected people can source or obtain water, the packet 510 can be dropped into the water and the person can consume a nutritious beverage in less than two minutes. In a mass casualty situation, the water obtained by the affected persons would normally be at room temperature which corresponds to the air temperature. The temperature of the water, if left long enough in a room, will either be equal to the room temperature or slightly lower due to evaporative cooling of the water if the water is held in an open top container. Nevertheless, this provides the general temperature of the water in which the packet 510 may be dropped into in order to provide the person with the nutritious beverage.

The packet 510 may have a film that is dissolvable and formed into a tubular configuration. The ends of the tube may be sealed (i.e., end seals) and the length of the tube (i.e., fin seal) may be sealed as well. This forms an airtight interior volume 530 of the packet 510. The interior volume 530 is filled with a powdered nutrient. The powdered nutrient is sized to be between 1 μm and 1000 μm. The powdered nutrient can be suspended in the water as a heterogeneous solution when dispersed in the water. The powdered nutrient may be provided in a dry state.

When the powdered nutrient is disposed within the tube 526, the interior volume 530 is filled with the powdered nutrient 522 and air. Instead of air, the manufacturing process used to manufacture the packet 510 may insert an inert gas or dehumidified air in order to slow down or eliminate any degradation of the powdered nutrient 522 when the packet 510 is being stored on the shelf. This increases the shelf life of the packet 510. Nevertheless, a gas (e.g. air, inert gas, food preservative gas) may be filled in the interior volume 530. The food preservative gas reduces the presence of oxygen within the interior volume 530 and an increase in nitrogen or carbon dioxide in the interior volume 530. When the packet 510 is filled with air, the packet 510 tends to float on the water. As such, it is also contemplated that the packet 510 may be vacuum packed and sealed so as to remove any air from the interior volume 530 of the packet to encourage the packet 510 to sink down into the water and to further decrease the time to dissolve the film.

When the packet 510 is inserted into the water bottle 512, the packet 510 floats to the water line 518 because of the gas in the interior volume 530 of the packet 510. As long as a portion of the packet 510 contacts the water, such portion will dissolve into the water as a homogeneous solution and eventually allow the powdered nutrients 522 in the packet 510 to be dispersed into the water 524 as a heterogeneous solution. Even if the entire packet 510 is not submerged in the water 524, the contents of the packet 510, namely, the powdered nutrients 522 can be evenly distributed throughout the water 524 in less than two minutes because there are no internal divisions within the interior volume 530 which would require the entire tube 526 to dissolve first before the powdered nutrients 522 is dispersed in the water 524. Rather, as soon as a hole is made in the tube 526, water 524 will seep into the interior volume 530 of the tube 526 and begin to dissolve the film from the inside out to further accelerate dissolving of the tube 526 in the film from which it is made. Additionally, the powdered nutrients 522 inside of the interior volume 530 will begin to mix with the water 524.

When the packet 510 is dropped into the water bottle 512, the packet 510 and anything associated with the packet 510 that are dropped into the water bottle are ingested by the person. Also, tube 526 dissolves into the water as a homogeneous solution and the contents of the tube 526, namely, the powdered nutrient is dispersed and suspended within the water to form a heterogeneous solution. Once the tube 526 has dissolved and the powdered nutrient has been dispersed, the user may drink the nutritious beverage without having to remove anything from the water 524 before drinking the beverage. Everything within the nutritious beverage is ingestible by the person.

Although the powdered nutrient has been described as forming a heterogeneous solution with the water, it is also contemplated that the powdered nutrient may also dissolve in the water but the time required to dissolve the powdered nutrient may be longer than the time required to dissolve the film. In order to accomplish this relative time for dissolving the film and the powdered nutrient, the thickness of the film and the size of the powder of the nutrient may be increased or decreased in order to account for the respective times to dissolve the film and the powdered nutrient. The powdered nutrient can be non-dissolvable or capable of being dissolved in water but dissolve very slowly so that effectively the powdered nutrient forms a heterogeneous solution with the water at the time the user consumes the mixed drink. For example, the powdered nutrient can dissolve in the water at such a slow rate so that it takes about five minutes for the powdered nutrient to completely dissolve while it takes about two minutes for the film to dissolve in still water at 45° F.-50° F. with the pH of 7 so that at the time of consumption, the powdered nutrient is consumed by the user when it is dispersed in the water as a heterogeneous solution.

Other respective times for dissolving the film and the powdered nutrient are also contemplated. For example, the time required to dissolve the film into the water may be equal to the time required to dissolve the powdered nutrient into the water. In this situation, when the packet is submersed in water, the water begins to dissolve the film. Once a hole is formed through the film, water enters the film and begins to dissolve the film from the inside out. After waiting about two minutes without agitating the water, the film is dissolved in the water and the powdered nutrient is also dissolved in water or almost completely dissolved based on the delay in time because the water had to dissolve through the film for the water to make contact with the powdered nutrient. Moreover, if the water is agitated by closing the water bottle and shaking the water bottle, the undissolved powdered nutrient rubs against the film and decreases the time it takes for the film to dissolve into the water. The friction created by the powdered nutrient rubbing against the film when shaking the bottle reduces the time for the film to dissolve into the water. In this regard, the drink may be provided in less than 30 seconds. In other words, by shaking the water bottle, the film may be dissolved into the water as a homogeneous solution and the powdered nutrient may be dispersed into the water is a heterogeneous solution or a homogeneous solution depending on the time for the powdered nutrient to dissolve into the water due to the size of the powder of the nutrient.

It is also contemplated that the time required to dissolve the film into the water may be greater than the time required to dissolve the powdered nutrient into the water.

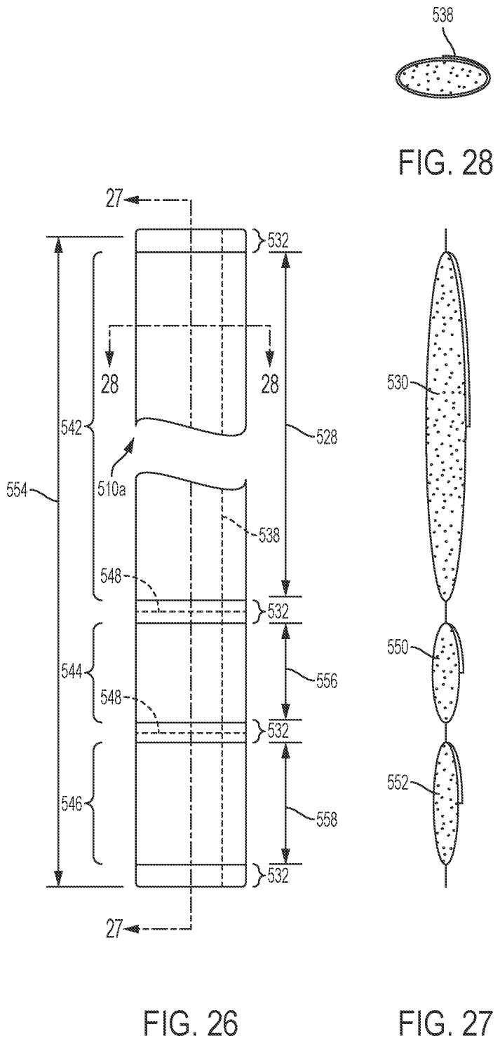

Referring now to FIGS. 26-28, the packet 510a is shown. The packet 510a is different from the packet 510 shown in the prior figures in that the packet 510a has multiple compartments 542, 544, 546. The packet 510a is shown as having three compartments 542, 544, 546 but it is also contemplated that the packet 510a may have two compartments or more than three compartments. The compartment 542 is the first compartment and defines the first interior volume 530 discussed above in relation to packet 510. The packet 510a is shown as having two additional compartments 544, 546 which are disposed sequentially after the compartment 542. The two additional compartments 544, 546 may optionally be detachable from the main compartment 542 prior to submersing the packet 510a into the water.

The compartments 544, 546 may have other food products that may be complementary in taste with the food product disposed within the compartment 542. The compartments 542, 544, 546 may be separated by horizontal seals 532 which may have a perforation 548 used to separate the compartments 542, 544, 546 apart from each other as desired. The perforations 548 extend across the entire width of the packet 510 namely along the horizontal seals 532. The perforations 548 may be utilized to detach either one or both of the compartments 544, 546. Similar to the packet 510, the end portions may also have seals 532. The compartments 542, 544, 546 define an interior volume 530, 550, 552.

A length 54 of the packet 510a may be greater than an interior height 536 of the water bottle 512. In that case, when the packet 510 is inserted into the water bottle, the packet 510a may bend at the central horizontal seals 532 between compartments 542, 544 and compartments 544, 546. Preferably, length 528, 556, 558 is shorter than the interior height 536 of the water bottle 512. Additionally, the length 556 of the central compartment 544 is smaller than an interior diameter of the water bottle 512 so that the packet 510a can be folded into a zigzag pattern within the bottle 512 as the packet 510a is being folded into and disposed within the water bottle 512.

Interior volumes 550, 552 of the compartments 544, 546 may be filled with a powdered food product that is complementary to the powdered food product disposed within the interior volume 530 of the first compartment 542.

The packet 510a also allows the user to drop the packet 510a into the water bottle 512 through the mouth of the water bottle 512. The user waits two minutes or less and allows the tube of the packet 510 to dissolve into still water as a homogeneous solution and allows the powdered nutrients 522 disposed within the first compartment 542 and the powdered food product within the second and third compartments 544, 546 to be dispersed within the water as a heterogeneous solution. This all happens within two minutes or less after dropping the packet 510 into still water so that the user can drink a nutritious beverage within two minutes. To reduce the time it takes for the user to drop the packet 510 into the water and drink the nutritious beverage, the user may close the bottle and shake it in order to allow the powdered nutrient to further act as mechanism for rubbing against the film and reducing the time it takes for the film to dissolve into the water and allow the powdered nutrient to be dispersed into the water.

The length 528, 556, 558 of the interior volume 530, 550, 552 may be between 2 inches and 512 inches. Preferably, the length 526, 556, 558 of the interior volume 530, 550, 552 may be between 3 to 7 inches. The compartments 542, 544, 546 is not rigid and can bend slightly so that if needed, the packet 510a can be squished into the bottle 512 by forcing the packet 510a, and more particularly the compartments 542, 544, 546 into the bottle 512 completely. Even if the tube 526 of the packet 510a breaks, when squished into the disposable water bottle 512, this is not a detriment to the utility of the packet 510a because the goal of the packet 510 is to quickly disburse the powdered food products within the compartments 542, 544, 546 into the water.

Similar to the packet 510, the packet 510a may also have the seal along fin 538. The fin seal is airtight which along with the airtight seals of the end portions 532 and the horizontal seals 532 to fully encapsulate the interior contents (e.g. powdered food products) within the compartments 542, 544, 546 so that moisture in the air does not degrade the quality of the powdered food products within the compartments 542, 544, 546 over an extended period of time.

The film used to fabricate the tube 526 of the packet 510a may be hydroxypropyl methyl cellulose. The hydroxypropyl methyl cellulose film may be provided in a thickness sufficient to allow the hydroxypropyl methyl cellulose film to dissolve in still drinking water at a pH of 7 having a temperature of 45° F.-50° F. in less than two minutes. By way of example and not limitation, the thickness of the hydroxypropyl methyl cellulose film may be between 1 thousands of an inch (i.e., 0.001″) and 510 thousands of an inch (i.e., 0.010″).

The temperature of the drinking water in the disposable water bottle 512 may be 45° F.-50° F. in the pH of the water may be 7. Thickness of the hydroxypropyl methyl cellulose film may be at a lower range when the temperature of the drinking water is colder than 45° F.-50° F. and the pH of the drinking water is below 7. In use, the packet 510a may be distributed to people in a mass casualty situation. The packet 510a provides nutrients to people affected by the mass casualty situation. The packet 510a can be dropped into the water and the person can consume a nutritious beverage in less than two minutes. In a mass casualty situation, the water obtained by the affected person would normally be at room temperature which corresponds to the air temperature or slightly less if the container holding the water has an open top.

When the packet 510a is inserted into the water bottle 512, the packet 510a may float to the water line 518 because of the gas in the interior volume 530, 550, 552 of the compartments 542, 544, 546 of the packet 510a. As long as a portion of each of the compartments 542, 544, 546 of the packet 510a contacts the water, such portion will dissolve into the water as a homogeneous solution and allow the powdered food product in each of the compartments 542, 544, 546 of the packet 510a to be dispersed into the water 524 as a heterogeneous solution. Even if the entire compartment 542, 544, 546 of the packet 510a is not each fully submerged in the water, the contents of the packet 510a, namely, the powdered nutrients 522 in the compartment 542 and the powdered food products in the compartments 544, 546 can be evenly distributed throughout the water 524 in less than two minutes because the water will dissolve a portion of the compartments 542, 544, 546 and allow water to seep into the compartments 542, 544, 546 and begin to dissolve the dissolvable film from the inside out. At this point, the water dissolves the external film both from the outside in and the inside out directions.

When the packet 510a is dropped into the water bottle 512, the packet 510a and anything associated with the packet 510a into the water bottle 512 may be ingested by the person. The packet 510a is the only thing that is dropped into the water of the bottle 512. Also, the tube 526 dissolves into the water as a homogeneous solution and the contents of the tube, namely, the powdered nutrients and the powdered food products are dispersed and suspended within the water to form a heterogeneous solution. Once the tube 526 of the packet 510a has dissolved and the powdered nutrients and the powdered food products have been dispersed into the water, the user may drink the nutritious beverage without having to remove anything from the water 524 before drinking the beverage. Everything in the nutritious beverage may also be ingested by the person. The time it takes for the user to drop the packet 510a into the water bottle and drink the nutritious beverage may be reduced by closing the water bottle and shaking the water bottle to allow the powdered nutrient to also rub against the film and decreased the time it takes for the film to completely dissolve into the water.

The packet 510, 510a is filled with a powdered nutrient. As discussed above, the powdered nutrient has a granularity of about 1 μm to 1000 μm. The powdered nutrient may be dispersed in the water as a heterogeneous solution. The powdered nutrient may be of a form that does not dissolve in the water. However, it is also contemplated that the powdered nutrient may take a longer time to dissolve in water compared to the dissolvable film. For example, if the film dissolved in water in X seconds, then the powdered nutrient may dissolve in water in X +1 seconds. More particularly with respect to the packet 510, 510a, the powdered nutrient may completely dissolve in water after two minutes of being submersed in still water. The two minutes time period for the film to dissolve in water is for water that remains still and is not agitated. However, when the water is agitated, the time for the film to dissolve in water is significantly reduced. In particular, when the packet 510, 510a is immersed in water, the packet may float to the top of the water line. The portion of the packet 510, 510a which is submersed in water begins to dissolve. Once the water has dissolved the portion of the packet 510, 510a so that water can enter the interior volume, the water begins to seep into the interior volume. At this time, the water begins to dissolve the film from the inside out and not only from the outside in as the process of dissolving initially started. If the water is agitated, then the water covers more of the film to thereby speed up the rate at which the film is dissolved and also the powdered nutrient which has not dissolved creates friction with the film to further help the film dissolve in the water.

The water may be agitated after the packet 510, 510a is submersed in water by closing the cover of the water bottle. In order to consume the powdered nutrient disposed in the packet 510, 510a, the user opens the water bottle and empties a portion of the water to allow room for the packet 510, 510a to be inserted into the water bottle so that water does not overflow out of the water bottle when the packet 510, 510a is inserted into the water bottle. Once the packet 510, 510a is inserted into the water bottle, the cover may be screwed back onto the opening of the water bottle to close the water bottle. Immediately, the water begins to dissolve the film. The user may shake the water bottle back and forth so that the water covers all of the film ones. Moreover, once the water dissolves through at least a portion of the film of the packet 510, 510a, the water seeps into the interior volume of the packet and begins to dissolve the film from the inside out. Additionally, due to the shaking of the water bottle, the powdered nutrients rub against the film to further decrease the time for the film to be completely dissolved homogeneously into the water. Since the powdered nutrients takes a longer time to dissolve into the water completely than the film or the powdered nutrient does not dissolve in water, the powdered nutrient acts to dissolve the film by rubbing against the film or impacting the film until the film is completely dissolved.

As discussed above, the powder of the nutrient may have a size of about 1 μm to about 1000 μm. Preferably, the size of the powder of the nutrient may be small enough so that even if the powder of the nutrient is not dissolved or become smaller once it is immersed in the water, as long as the powder is dispersed heterogeneously into the water, a full grown adult can drink the heterogeneous solution of powdered nutrient. However, it is also contemplated that the size of the powder of the nutrient may be sufficiently large so that a full grown adult cannot drink the resulting heterogeneous solution provided that the powder of the nutrient remains the same. In this case, when the size of the powder of the nutrient is larger than the size that a full grown adult can drink as a heterogeneous solution, the powder of the nutrient may be dissolvable so that within about 30 seconds to two minutes, the size of the powder of the nutrient is small enough so that the heterogeneous mixture of the powdered nutrient can be consumed by the person.

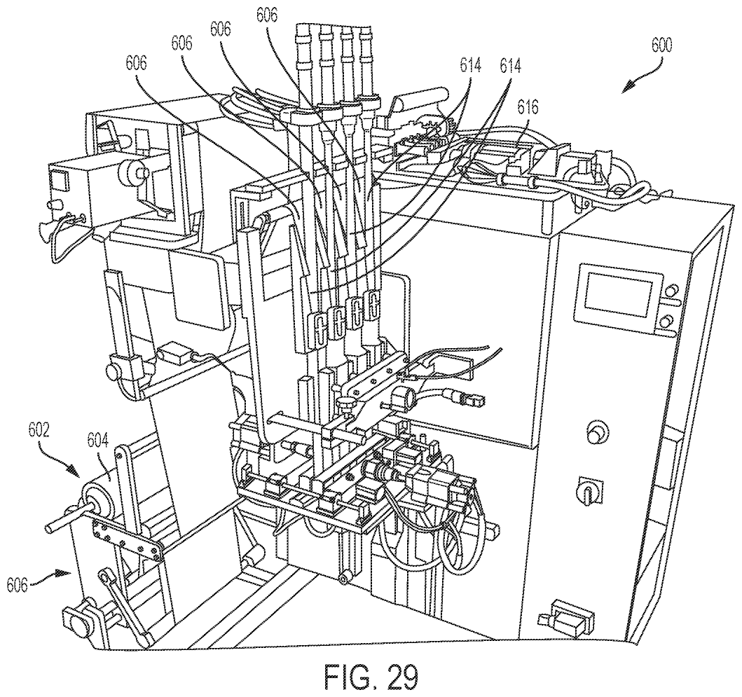

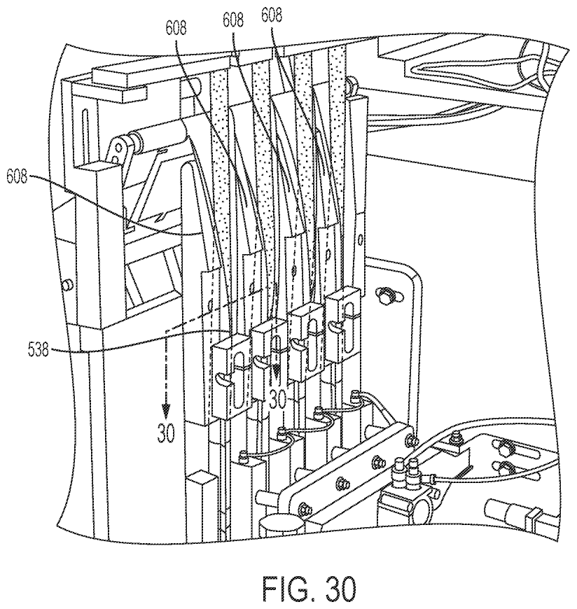

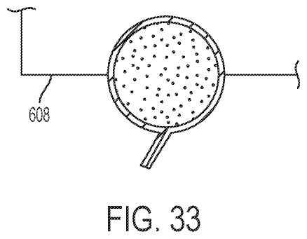

Referring now to FIGS. 29-33, a machine 600 for forming the packets 510, 510a is shown. The machine 600 may have a film loader 602 which holds a roll of film 604. As discussed above, the roll of film 604 may be a roll of hydroxypropyl methyl cellulose film. The roll of film 604 is fed through a series of tensioners 606 until it is slitted into four even strips 606. The film 604 is shown as being divided into four even strips 5606 but it is also contemplated that the roll of film 604 may be divided into two or more strips 606 (e.g. eight strips) and it is also contemplated that the roll of film 604 may be sufficiently narrow to support one strip 606. After the width of the roll of film 604 is cut down to size, the strips are folded so as to form a tube configuration is shown in FIG. 30. The strips 606 are folded with a die 608, as shown in FIGS. 30 and 33.

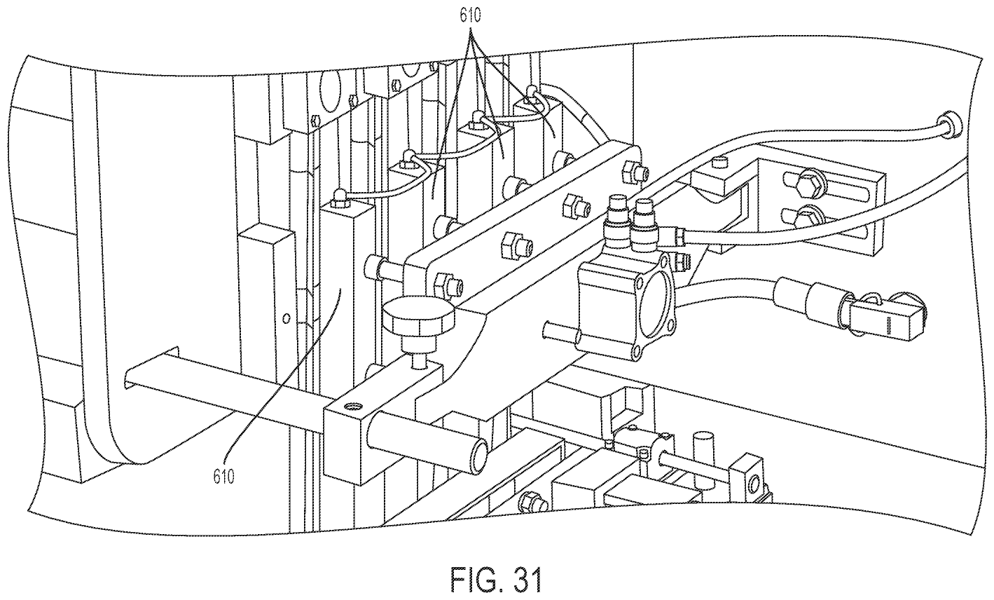

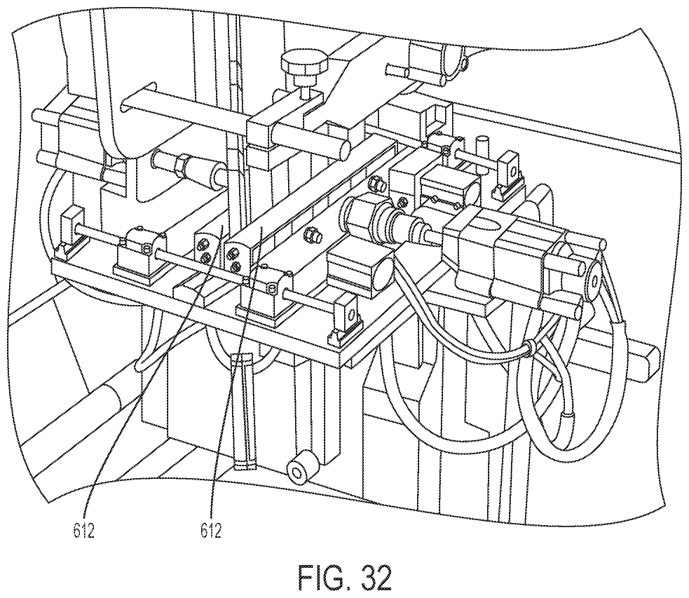

After the film is folded into a tube configuration, a heat seal forms a seal at the fins 538 along the longitudinal length of the tube configured strips 606. The heat is generated with heater 610, as shown in FIG. 31. After the end seal is formed, the end seals 532 are formed with horizontal seal bars 612 as shown in FIG. 32. The seal bars 612 forms the upper end seal of the lower packing 510, 510a and the lower end seal of the upper packet 510, 510a. The horizontal seal bars 612 may also be fitted with a perforator in order to create perforations 548 at the horizontal seals 532 between the compartments 542, 544 and compartments 544, 546. After the seal 532 is formed, the powdered food product is pumped into the tubular formed strips 606 via conduits 614. Pump 616 pumps the powdered food products into the conduits 614 and drops a specific amount of powdered food products into the tubular configured strips 606 as shown in FIG. 33. The horizontal seal bars 612 form the end seals 532 and also slits the upper and lower packets 510, 510a when appropriate and also forms only a perforations 548 when appropriate as well.

By way of example and not limitation, if the packet 510a has two or more compartments as shown in FIGS. 26-28, then the horizontal seal bars 612 seal the middle portion 532 and may optionally perforate the middle portion 532. At the end portions 532, the horizontal seal bars 612 seal the packet but also cut the packet to manufacture individual packets 510a.

As discussed herein, the packet 510, 510a contains powdered nutrient. The powder nutrient may be a powder protein nutrient. However, it is also contemplated that other powder nutrients which are not protein may be disposed in the packet 510, 510a. By way of example and not limitation, the powder nutrient may be protein formulations, carbohydrates, fats, vitamins, minerals, sweeteners, caffeine or combinations thereof. Additionally, these alternative powder nutrients may share the same characteristic as that of the powder nutrient discussed above in relation to all aspects of the powder nutrient including but not limited to time to dissolve, non-dissolvability, and rate of dissolving. Moreover, these alternative powder nutrients may have a relative time to dissolve with respect to the film and behave the same way as the powder nutrient in decreasing the time to dissolve the film into the water.

The interior volume 530 of the compartments of the packet 510 may have a volume x. The powder nutrient may fill the interior volume 530 to a certain percentage less than 100% so that the powder nutrient moves about within the interior volume 530 if the water bottle is shaken. Such movement creates friction against the film and decreases the time for the film to dissolve into the water. In this regard, the powder nutrient may fill the interior volume 530 at about a 50%, 60%, 70% level with respect to the volume x.

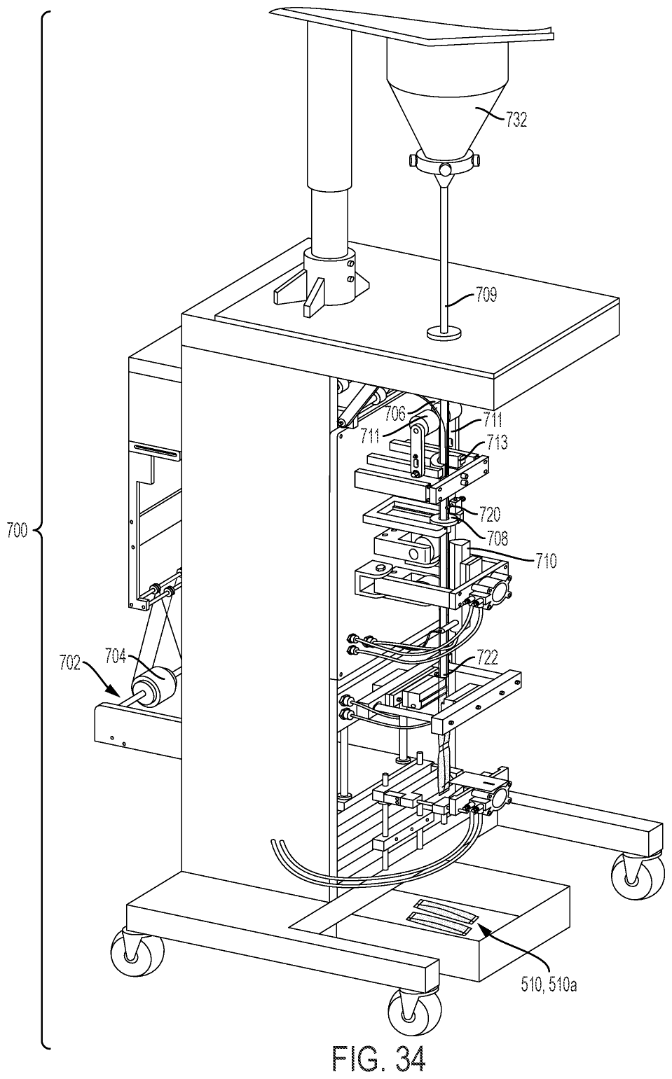

Referring now to FIGS. 34-40, a machine 700 which may be identical to machine 600 for forming the packets 510, 510a is shown except for the following features discussed and shown in relation to FIGS. 34-40. The machine 700 may have a film loader 55702 which holds a roll of film 704. The film loader 702 may have a rod 800 that can be removed from a frame of the machine 700 so that the roll of film 704 can be mounted to the rod 800 when needed. As discussed above in relation to roll of film 604, the roll of film 704 may be a roll of hydroxypropyl methylcellulose film. Although the various aspects and embodiments have been described in relation to a roll of film fabricated from a hydroxypropyl methyl cellulose film, other materials are also contemplated including but not limited to rice paper, tapioca powder, Amylose, Amylopectin, Silk (Fibroin) Gelatin, Casein, Pullulan, Guar gum, Soybean polysaccharide film, Agar-agar, Arabinoxylan, Alginate sodium, Callaneenan film, Pectin, Hydroxy propyl cellulose film (i.e., HPC film), Hydroxy propyl methyl film (i.e., HPMC film) Carboxymethyl cellulose film, Carboxymethyl film, Decaglycerin monitor myristate, Glycerin, Crystalline cellulose, Hydroxypropylcellulose or combinations thereof. An exemplary combination may be Decaglycerin monitor myristate, Glycerin, Crystalline cellulose, Hydroxypropylcellulose which is provided in film form with a thickness of about 0.004 inches thick. The thickness may have a range between 0.001 and 0.010 inches. The roll of film 704 may be fed through a series of tensioners (not shown) located at the rear of the machine 700. The tensioners allow the film 604, 704 to be pulled off of the roll 704 and feed the film into the machine 700. In FIG. 34, the film is not split into multiple strips 706 because the strip width is pre-sized to form only one packet 510, 510a. However, it is contemplated that film 704 may be sufficiently wide to be slit into multiple strips similar to machine 600 so that the machine 700 can be used to fill and manufacture packets at the same time at a rate similar to machine 5600.

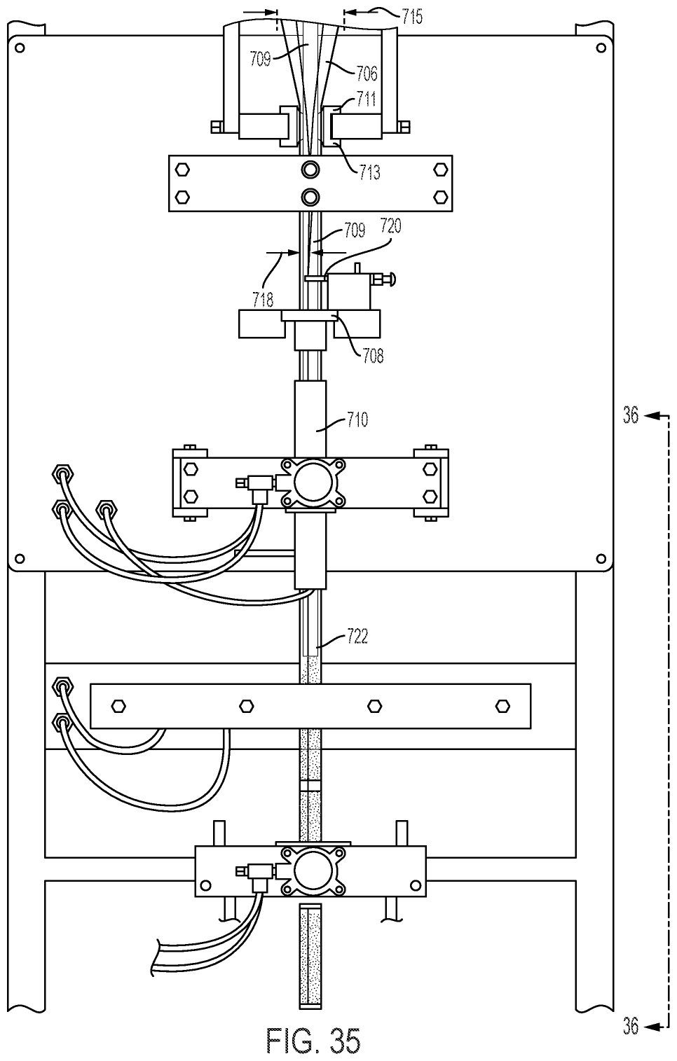

The strip may be folded so as to form a tube configuration. The strip 706 may be completely folded within a die 708 and around tube 209. The tube 209 is disposed within and sized to an inner circumference of the die 708 so that the film or strip may retain its tubular configuration when the vertical fin seal is made. More particularly, when the strip 706 is fed to the front of the machine through the tensioners, as shown in FIG. 35, the strip 706 may be bent against and around the tube 209 with the roller 211. The roller 211 may partially hug the tube 209 so that the film or strip 706 is partially folded around the tube 209. The strip 706 begins to form into a round tube with the aid of the roller 211 and the tube 209. The roller 211 pushes the strip 706 around the tube 209. The strip 706 is further conformed or shaped around the tube 209 with the die 708 that fully circumscribes the entire tube 209. Hydroxypropyl methylcellulose film with a thickness in the lower range of the 0.001 inches to 0.0510 inch range may be flimsy in that a 1 inch square piece of the film would could not be supported vertically if held vertically at its bottom edge portion. For example, a 0.001 inch thick film of hydroxypropyl methylcellulose 1 inch square would fold over when held vertically at the bottom edge portion of the square piece of film. The roller 211 helps to maintain the shape of the film as it is being formed into a tubular configuration even when the film is flimsy and cannot support its own weight, as discussed.

The width 215 of the strip 706 when the strip 706 is flat without being curved by roller 211 may be greater than a circumference of the tube 209. This allows enough room for opposed edge portions 518 of the strip 706 to overlap and be vertically heat sealed together to form the vertical fin seal. The opposed edge portions 2518 may be held down and in place with a needle 720. The needle 720 may be adjusted to help position the opposed edge portions 518 of the strip 706. Before the strip 706 enters the die 708, the strip 706 fully circumscribes the tube 709 and the opposed edge portions 518 are folded over each other which will form the fin seal.

A vertical heater 710 may be pressed against the tube 709 on the opposed edge portions 518. The strip 706 may be coated with a heat activated adhesive so that the opposed edge portions 518 are sealed together when the vertical heater 710 applies heat to the opposed edge portions 518. The sealed edge portions 518 define the fin seal.

With the opposed edge portions 518 sealed together, the strip 706 forms a tubular configuration. When the machine 700 is running, the machine 700 serially produces a series of packets 510, 510a.

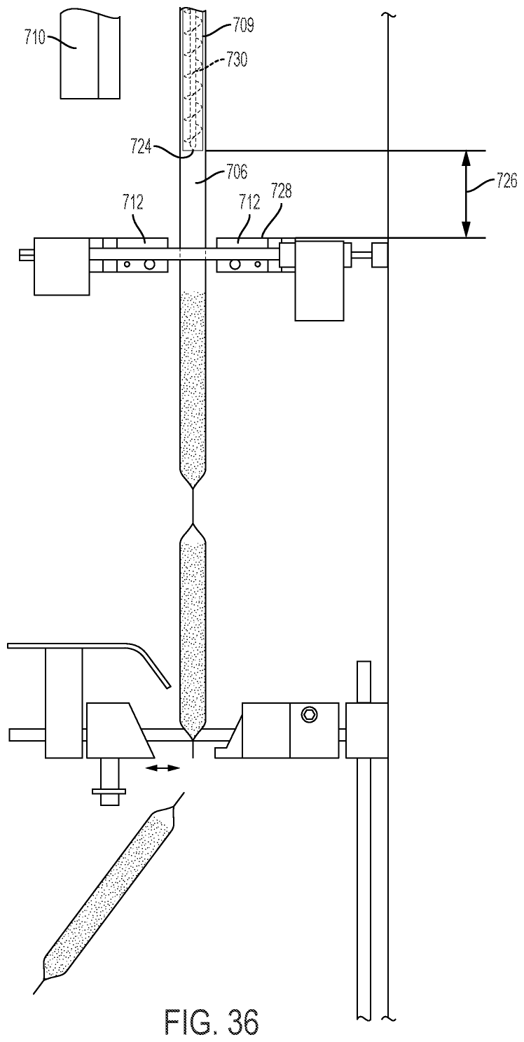

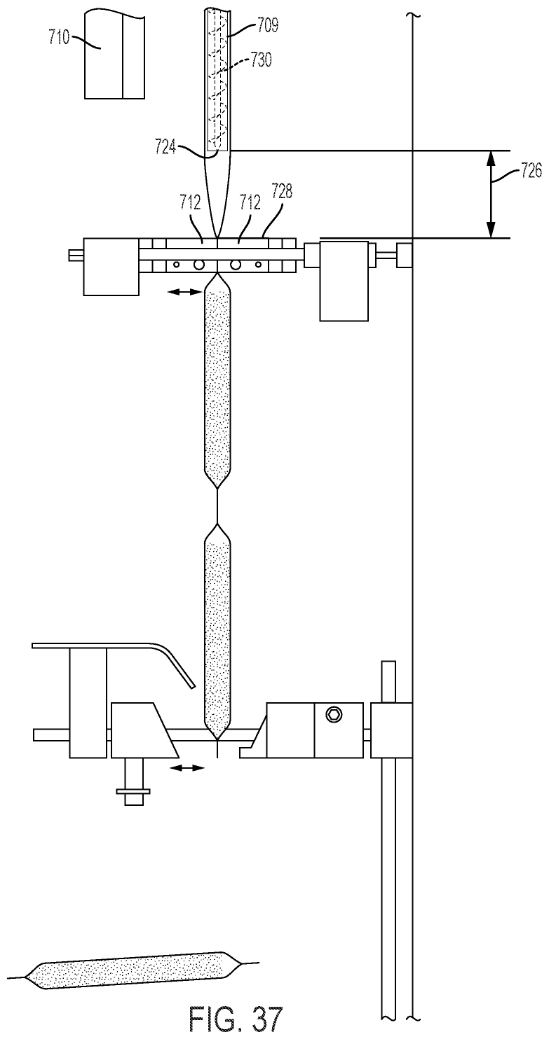

In the position shown in FIG. 36, horizontal heaters 712 are in the retracted position and do not touch the tube configured strip 706. The tube 709 has a distal end 524. The distal end 524 of the tube 709 is very close to the horizontal heaters 712. In this regard, a distance 726 between the distal end 724 of the tube 709 and the top 728 of the horizontal heater 712 may be between ½ inch and 5 inches. Preferably, the distance 726 is between about 0.5 inches to 4 inches and more preferably between 1 inch to 2.5 inches. When the horizontal heaters 712 clamp down on the strip 706, as shown in FIG. 37, the film forms a wedge shaped tube that spans distance 726 between the top 728 of the horizontal heaters 712 and the distal end 524 of the tube 709. The wedge shape of the tubular configuration prevents the powdered food product from hitting a flat bottom surface and mitigates the powdered food product from becoming airborne. The powdered food product may have a mesh size between 580 mesh and 700 mesh. The interior surfaces of the wedge shaped tube allow the powdered food product to slide down to the lower apex of the wedge shaped tube. Moreover, the short distance 526 does not allow the powdered food product to gain speed so that when the powdered food product is stopped, the powdered food product does not form a dust cloud. Because the size of the powder of the powdered food product is so small, the powdered particulates may have a tendency to become airborne when transferred or disturbed. The short distance 726 mitigates the powdered food product from becoming airborne as the powder is flowing down the sides of the wedge shaped tube. The short distance 726 reduces the amount of time that the powdered food product is in free fall and thus speed in order to fill the tubular configured film. When the horizontal heaters 712 create the horizontal seal, as shown in FIG. 37, an auger 730 begins to rotate and allow the powdered food product to flow through the tube 709 and out of the distal end 724 into the tubular configured strip or film. The distal end of the auger is close to the distal end 724 of the tube 709. In this regard, the augur allow the powdered food product to fill the tube 709 up to and close to the distal end 724 of the tube 709. The powdered food product does not drop from the hopper 2532 but begins to drop down closer to the distal end 724 of the tube 709 and more particularly, the distal end of the auger 730 which would be at or slight above the distal end 724 of the tube 709.

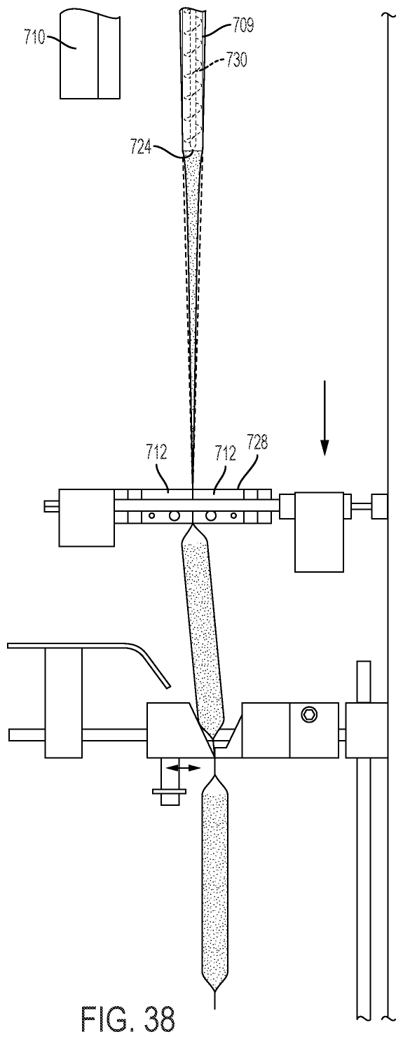

After the powdered food product begins to flow out of the distal end 724 of the tube 709 because of the turning of the auger 730, the horizontal heaters 712 which are in the closed position pull the strip downward, as shown in FIG. 38. The strip between the top 728 of the horizontal heaters 712 and the distal end 724 of the tube 709 is increasing. Since air may not be allowed to freely flow into the tubular configured strip therebetween 728, 724, a slight vacuum may be created which may curve the sides of the wedge shaped tube inward as shown in FIG. 38. In FIG. 38, the dash lines between the distal end 724 and the top 728 of the horizontal heaters is a straight line between the tube 709 and the horizontal seal formed by the horizontal heaters. The film is shown as being curved inward due to the slight vacuum formed. The powdered food product is continually fed into the wedge shaped tube while the horizontal heaters 712 pull the strip down. Because the powdered food product contacts the inwardly curved sides of the tubular configured strip, the powdered food product is less likely to form a dust cloud and slide down the sides of the film/strip. The curved sides further mitigate the potential of the powdered food product from becoming airborne in the tube and excessively contaminating the adhesive layer which might prevent a good seal from forming horizontally when the horizontal heaters 712 press against each other to form the horizontal seal. The powdered food product is continually fed into the tubular configured strip by rotating the auger 730 until a predetermined amount of powdered food product is filled in the wedge shaped tube.

When the predetermined amount of powdered food product is disposed within the tubular configured strip, the auger 730 stops rotating and powdered food product stops exiting the tube 709. Additionally, a knife mechanism 734 cuts the strip at some point where the horizontal heaters 712 created a horizontal seal to create the packet 710, 710a.

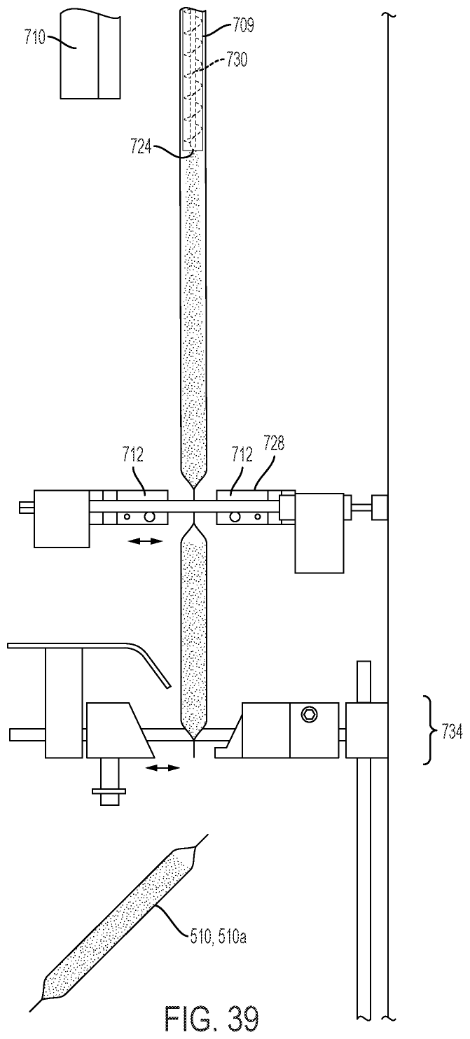

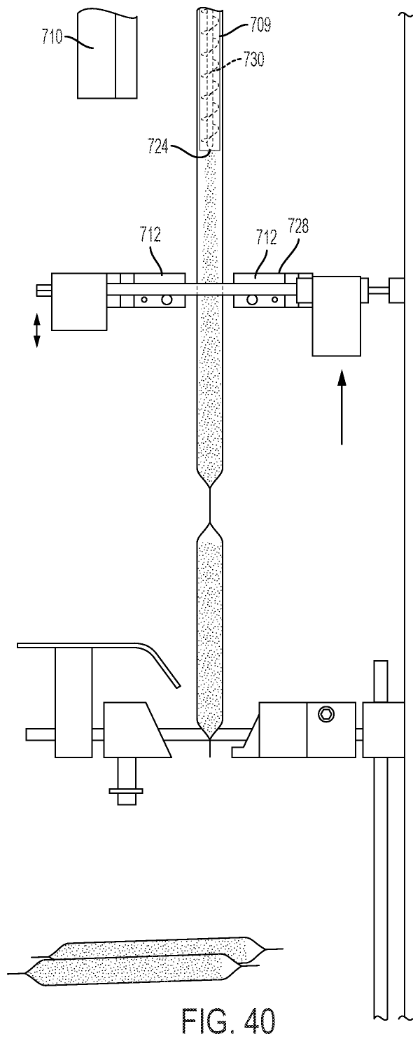

The knife mechanism is opened and the heaters 712 are opened, as shown in FIG. 39. The heaters 712 are also brought back up to the position shown in FIG. 36, as shown in FIG. 40. As shown in FIG. 40, the next packet 710, 710a is being filled so that the cycle is repeated beginning from FIG. 36 to FIG. 40.

The perforator discussed in relation to machine 100 may also be incorporated into the machine 700 for creating packets 10a.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of manufacturing a solid form having a binder and an ingestible food product for conveniently mixing the ingestible food product with drinkable water, the method comprising the steps of:
providing the ingestible product as a plurality of granules or powder;
providing an ingestible water dissolvable binder that is dissolvable in 80 degree Fahrenheit water in under 10 minutes when the ingestible water dissolvable binder is submersed under water and the water is still;
mixing the ingestible water dissolvable binder and the powdered ingestible food product;
filling a cavity of a die with the mixed ingestible water dissolvable binder and powdered ingestible food product;
binding the powered ingestible food product into the solid form with the ingestible water dissolvable binder.

2. The method of claim 1 wherein a dimension of the cavity is so that a width of the solid form is smaller than a mouth of a container and a length of the solid form is shorter than a height of the container.

3. The method of claim 1 wherein the ingestible food product is sugar, coffee, flavor, protein or combinations thereof.

4. The method of claim 1 wherein the ingestible water dissolvable binder is cellulose based, rice based.

5. The method of claim 1 wherein the ingestible water dissolvable binder is provided in a liquid form.

6. The method of claim 1 wherein the food product is a flavor, sugar, coffee, protein, carbohydrate or combinations thereof.

7. A dissolvable food product comprising:
a powder food product;
a binder mixed with the powdered food product to hold the powder food product together as a solid form.

8. The food product of claim 7 wherein the powder food product is sugar, coffee, carbohydrate, protein, flavoring, or combinations thereof.

9. The food product of claim 7 wherein the binder is cellulose.
